(19) United States
(12) Patent Application Publication
(10) Pub. No.: US 2019/0215084 A1
(43) Pub. Date: Jul. 11, 2019

(54) METHOD, SYSTEM AND APPARATUS

(71) Applicant: NOKIA SOLUTIONS AND NETWORKS OY, Espoo (FI)

(72) Inventors: Riikka Karoliina NURMINEN, Helsinki (FI); Lars DALSGAARD, Oulu (FI); Antti-Veikko Sakari PIIPPONEN, Vantaa (FI)

(21) Appl. No.: 16/310,652

(22) PCT Filed: Jun. 27, 2016
(86) PCT No.: PCT/EP2016/064897

§ 371 Date: Dec. 17, 2018

(51) Int. Cl. H04B 17/24; H04B 17/318; H04B 17/382; H04W 16/14; H04W 76/38; H04W 24/10

(52) U.S. Cl. CPC H04B 17/24; H04B 17/318; H04W 24/10; H04W 16/14; H04W 76/38; H04B 17/382

(57) ABSTRACT

There is provided a method comprising determining that a time period associated with measurement requirements for performing reference signal measurements exceeds a threshold, such that the measurement requirements are not satisfied and providing measurement information to an access point, the measurement information comprising an indication that the measurement requirements are not satisfied.

### FIELD

The present application relates to a method, apparatus, system and computer program and in particular but not exclusively to a method and apparatus for use in a network which may operate in a network resource sharing environment.

### BACKGROUND

A communication system can be seen as a facility that enables communication sessions between two or more entities such as user terminals, base stations/access points and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station or access point, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (the term used by 3GPP) networks. Standardization of 5G or New Radio networks is currently under discussion. LTE is being standardized by the 3rd Generation Partnership Project (3GPP).

### SUMMARY

In a first aspect, there is provided a method comprising: at a user device, determining that a time period associated with measurement requirements for performing reference signal measurements exceeds a threshold, such that the measurement requirements are not satisfied and providing measurement information to an access point, the measurement information comprising an indication that the measurement requirements are not satisfied.

The time period may comprises at least one of a time period between receiving a first reference signal and a second reference signal and a maximum time period for performing reference signal measurements.

Determining that the time period exceeds a threshold may comprise determining that a defined number of reference signal transmissions are not present within the maximum time period.

The method may comprise performing at least one reference signal measurement of a plurality of reference signal measurements, wherein the measurement requirements comprise performing a plurality of reference signal measurements and wherein the information comprises an indication of the at least one reference signal measurement.

The measurement information may comprise an indication of the number of performed reference signal measurements.

The method may comprise providing the measurement information on expiry of a timer.

The method may comprise providing the measurement information after triggering of a measurement event.

The method may comprise providing the measurement information using unlicensed spectrum.

In a second aspect, there is provided a method comprising, at a network element, receiving measurement information from a user device, the measurement information comprising an indication that measurement requirements for performing reference signal measurements are not satisfied, wherein the user device has determined that a time period associated with the measurement requirements exceeds a threshold, such that the measurement requirements are not satisfied.

The time period may comprise at least one of a time period between receiving a first reference signal and a second reference signal and a maximum time period for performing reference signal measurements.

The method may comprise causing transmission of at least one reference signal measurement of a plurality of reference signal measurements, wherein the measurement requirements comprise performing a plurality of reference signal measurements and wherein the information comprises an indication of at least one reference signal measurement.

The measurement information may comprise an indication of the number of performed reference signal measurements.

The method may comprise receiving the measurement information on expiry of a timer.

The method may comprise receiving the measurement information after triggering of a measurement event at the user device.

The method may comprise receiving the measurement information using unlicensed spectrum.

In a third aspect, there is provided an apparatus, said apparatus comprising means for determining that a time period associated with measurement requirements for performing reference signal measurements exceeds a threshold, such that the measurement requirements are not satisfied and means for providing measurement information to an access point, the measurement information comprising an indication that the measurement requirements are not satisfied.

The time period may comprises at least one of a time period between receiving a first reference signal and a second reference signal and a maximum time period for performing reference signal measurements.

Means for determining that the time period exceeds a threshold may comprise means for determining that a defined number of reference signal transmissions are not present within the maximum time period.

The apparatus may comprise means for performing at least one reference signal measurement of a plurality of reference signal measurements, wherein the measurement requirements comprise performing a plurality of reference signal measurements and wherein the information comprises an indication of the at least one reference signal measurement.

The measurement information may comprise an indication of the number of performed reference signal measurements.

The apparatus may comprise means for providing the measurement information on expiry of a timer.

The apparatus may comprise means for providing the measurement information after triggering of a measurement event.

The apparatus may comprise means for providing the measurement information using unlicensed spectrum.

The apparatus may be a user device or an apparatus associated with a user device.

In a fourth aspect, there is provided an apparatus comprising means for receiving measurement information from a user device, the measurement information comprising an indication that measurement requirements for performing reference signal measurements are not satisfied, wherein the user device has determined that a time period associated with the measurement requirements exceeds a threshold, such that the measurement requirements are not satisfied.

The time period may comprise at least one of a time period between receiving a first reference signal and a second reference signal and a maximum time period for performing reference signal measurements.

The apparatus may comprise means for causing transmission of at least one reference signal measurement of a plurality of reference signal measurements, wherein the measurement requirements comprise performing a plurality of reference signal measurements and wherein the information comprises an indication of at least one reference signal measurement.

The measurement information may comprise an indication of the number of performed reference signal measurements.

The apparatus may comprise means for receiving the measurement information on expiry of a timer.

The apparatus may comprise means for receiving the measurement information after triggering of a measurement event at the user device.

The apparatus may comprise means for receiving the measurement information using unlicensed spectrum.

The apparatus may be a network element, such as an eNB, or an apparatus associated with a network element.

In a fifth aspect, there is provided an apparatus comprising at least one processor and at least one memory including a computer program code, the at least one memory and the computer program code configured to, with the at least one processor, cause the apparatus at least to determine that a time period associated with measurement requirements for performing reference signal measurements exceeds a threshold, such that the measurement requirements are not satisfied and provide measurement information to an access point, the measurement information comprising an indication that the measurement requirements are not satisfied.

The time period may comprises at least one of a time period between receiving a first reference signal and a second reference signal and a maximum time period for performing reference signal measurements.

The apparatus may be configured to determine that a defined number of reference signal transmissions are not present within the maximum time period.

The apparatus may be configured to perform at least one reference signal measurement of a plurality of reference signal measurements, wherein the measurement requirements comprise performing a plurality of reference signal measurements and wherein the information comprises an indication of the at least one reference signal measurement.

The measurement information may comprise an indication of the number of performed reference signal measurements.

The apparatus may be configured to provide the measurement information on expiry of a timer.

The apparatus may be configured to provide the measurement information after triggering of a measurement event.

The apparatus may be configured to provide the measurement information using unlicensed spectrum.

The apparatus may be a user device or an apparatus associated with a user device.

In a sixth aspect, there is provided an apparatus comprising at least one processor and at least one memory including a computer program code, the at least one memory and the computer program code configured to, with the at least one processor, cause the apparatus at least to receive measurement information from a user device, the measurement information comprising an indication that measurement requirements for performing reference signal measurements are not satisfied, wherein the user device has determined that a time period associated with the measurement requirements exceeds a threshold, such that the measurement requirements are not satisfied.

The time period may comprise at least one of a time period between receiving a first reference signal and a second reference signal and a maximum time period for performing reference signal measurements.

The apparatus may be configured to cause transmission of at least one reference signal measurement of a plurality of reference signal measurements, wherein the measurement requirements comprise performing a plurality of reference signal measurements and wherein the information comprises an indication of at least one reference signal measurement. The measurement information may comprise an indication of the number of performed reference signal measurements.

The apparatus may be configured to receive the measurement information on expiry of a timer.

The apparatus may be configured to receive the measurement information after triggering of a measurement event at the user device.

The apparatus may be configured to receive the measurement information using unlicensed spectrum.

The apparatus may be a network element, such as an eNB, or an apparatus associated with a network element.

In an seventh aspect, there is provided a computer program embodied on a non-transitory computer-readable storage medium, the computer program comprising program code for controlling a process to execute a process, the process comprising at a user device, determining that a time period associated with measurement requirements for performing reference signal measurements exceeds a threshold, such that the measurement requirements are not satisfied and providing measurement information to an access point, the measurement information comprising an indication that the measurement requirements are not satisfied.

The time period may comprises at least one of a time period between receiving a first reference signal and a second reference signal and a maximum time period for performing reference signal measurements.

Determining that the time period exceeds a threshold may comprise determining that a defined number of reference signal transmissions are not present within the maximum time period.

The process may comprise performing at least one reference signal measurement of a plurality of reference signal measurements, wherein the measurement requirements comprise performing a plurality of reference signal measurements and wherein the information comprises an indication of the at least one reference signal measurement.

The measurement information may comprise an indication of the number of performed reference signal measurements.

The process may comprise providing the measurement information on expiry of a timer.

The process may comprise providing the measurement information after triggering of a measurement event.

The process may comprise providing the measurement information using unlicensed spectrum.

In an eighth aspect, there is provided a computer program embodied on a non-transitory computer-readable storage medium, the computer program comprising program code for controlling a process to execute a process, the process comprising, at a network element, receiving measurement information from a user device, the measurement information comprising an indication that measurement requirements for performing reference signal measurements are not satisfied, wherein the user device has determined that a time period associated with the measurement requirements exceeds a threshold, such that the measurement requirements are not satisfied.

The time period may comprise at least one of a time period between receiving a first reference signal and a second reference signal and a maximum time period for performing reference signal measurements.

The process may comprise causing transmission of at least one reference signal measurement of a plurality of reference signal measurements, wherein the measurement requirements comprise performing a plurality of reference signal measurements and wherein the information comprises an indication of at least one reference signal measurement.

The measurement information may comprise an indication of the number of performed reference signal measurements.

The process may comprise receiving the measurement information on expiry of a timer.

The process may comprise receiving the measurement information after triggering of a measurement event at the user device.

The process may comprise receiving the measurement information using unlicensed spectrum.

In a ninth aspect there is provided a computer program product for a computer, comprising software code portions for performing the steps the method of the first and second aspect when said product is run on the computer.

A device for a communication system may comprise the apparatus according to the above aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a plurality of base stations and a plurality of communication devices;

FIG. 2 shows a schematic diagram of an example mobile communication device;

FIG. 3 shows a flowchart of an example method according to some embodiments;

FIG. 4 shows a schematic diagram of an example control apparatus.

### DETAILED DESCRIPTION

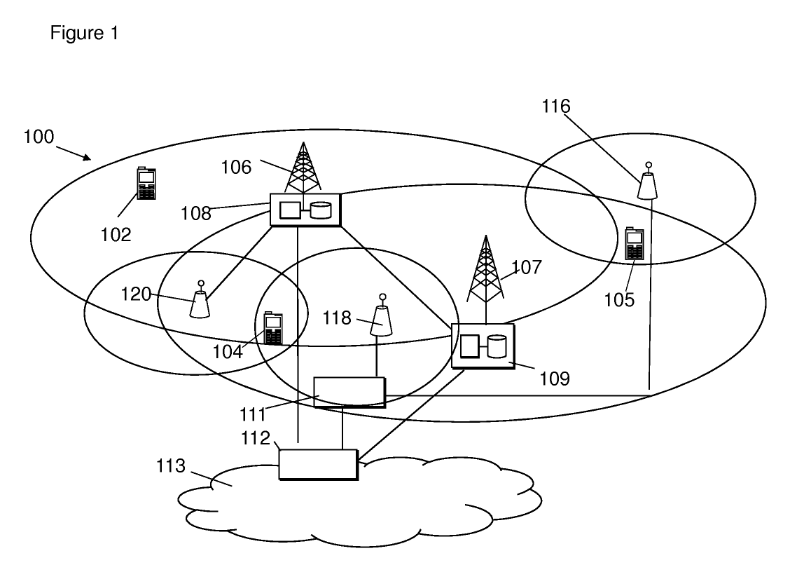

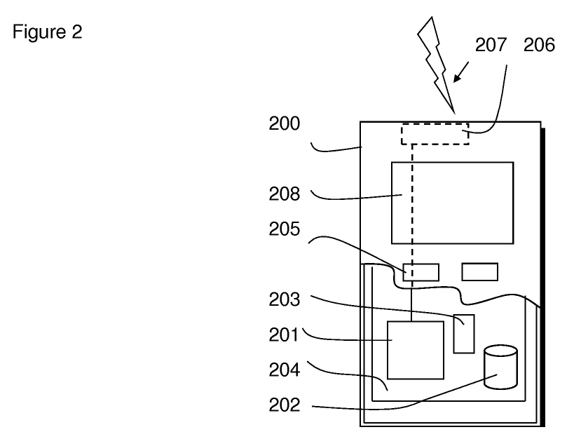

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. A base station is referred to as an eNodeB (eNB) in LTE. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. In some systems, the control apparatus may additionally or alternatively be provided in a radio network controller.

LTE systems may however be considered to have a so-called “flat” architecture, without the provision of RNCs; rather the eNB is in communication with a system architecture evolution gateway (SAE-GW) and a mobility management entity (MME), which entities may also be pooled meaning that a plurality of these nodes may serve a plurality (set) of eNBs. Each UE is served by only one MME and/or S-GW at a time and the (e) NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided.

A possible mobile communication device will now be described in more detail with reference to FIG. 2 showing a schematic, partially sectioned view of a communication device 200.

Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto. The communication devices 102, 104, 105 may access the communication system based on various access techniques.

An example of wireless communication systems are architectures standardized by the 3rd Generation Partnership Project (3GPP). A latest 3GPP based development is often referred to as the long term evolution (LTE) or LTE Advanced Pro of the Universal Mobile Telecommunications System (UMTS) radio-access technology. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

For more efficient spectrum utilization, wireless communication systems may be allowed to operate in unlicensed or licensed-shared spectrum bands, as well as or instead of licensed spectrum bands. A technology, for example LTE, may operate, in addition to a licensed band, in an unlicensed band. One proposal for operating in unlicensed spectrum is Licensed-Assisted Access (LAA). Currently, it is proposed with LAA that a connection via a licensed band can be enhanced by adding another second carrier being operated in the unlicensed band.

An alternative for utilising unlicensed spectrum is LTE standalone operation on unlicensed spectrum or temporarily shared spectrum resources. In LTE standalone operation, the eNB/UE air interface relies solely on unlicensed or temporarily shared spectrum without any carrier on licensed spectrum. An example of LTE standalone operation in unlicensed bands is the MuLTEfire technology proposed by the MuLTEfire Alliance.

Licensed Assisted Access (LAA) has been introduced in Rel-13. LAA enables LTE supplemental downlink operation in unlicensed carriers using carrier aggregation, where the unlicensed cell is always a secondary cell. Transmission in unlicensed carriers may be subject to Listen-Before-Talk (LBT) procedures, which means that eNodeB needs to listen to the unlicensed channel before transmission to make sure it is not occupied by other technologies or other LAA transmissions. In LTE operation on unlicensed carriers, depending on the regulatory rules, the UE may need to perform a clear channel assessment (CCA) or LBT procedure prior to at least some uplink (UL) or downlink (DL) transmissions.

Some LAA specific measurement and cell identification requirements have been defined. Maximum measurement time and cell identification time allowed under the impact of LBT are being considered. The following relates to measurement reporting in LAA, where the UE measurement time may be highly variable due to LBT and other factors.

Cell specific reference signals (CRS) and channel state information reference signals (CSI-RS) based radio resource management (RRM) measurements in LAA are allowed in discovery reference signal (DRS) occurring during DRS measurement timing configuration (DMTC), since, within DMTC, the UE may assume constant transmit power. CRS and CSI-RS based cell identification and measurement requirements for LAA cells may use Frame Structure 3 (FS3).

For LTE one solution has been defined for enabling eNB power savings in (small) LTE cells, namely the LTE (small) cell on/off where DRS is transmitted by the eNodeB every 40, 80 or 160 ms. Thus, the UE may always assume DRS to be transmitted. DRS also occurs always at the same position within the DMTC, so the UE does not have to detect DRS location, and can always perform measurements. The measurement report may be transmitted after the UE has measured over the required amount of DRS occasions, i.e. after n*T_{DMTC}_{_}_{periodicity} where T_{DMTC}_{_}_{periodicity} is the length of the DMTC periodicity. The measurement requirements may define the required amount of DRS. There may be variation in the measurement requirements depending on the measurement bandwidth, which can be seen below in Table 1 which shows example requirements for measuring FDD intra frequency cell.

TABLE 1
Requirement to measure FDD intra frequency cell

| | Discovery signal | |
|---|---|---|
| Measurement | occasion duration | |
| bandwidth | (ds-OccasionDuration) | T_{Measurement}_{_{—}}_{Period intra}_{_{—}}_{FDD}_{_{—}}_{CRS} |
| [RB] | [ms] | [ms] |
| ≥6 | ≥1 | 5 * T_{DMTC}_{_{—}}_{periodicity} |
| ≥25 | ≥1 | 3 * T_{DMTC}_{_{—}}_{periodicity} |

In LAA, measurement requirements may be defined for two different measurement bandwidths (<25 PRB and ≥25 PRB) and for two different shared channel (SCH) signal to interference plus noise ratio (SINR), Ės/Iot and CRS SINR, Ės/Iot levels. Thus, there are several measurement requirements the UE is specified to follow (for each of intra-, and inter-frequency, discontinuous reception (DRX) and non-DRX) and these may differ in duration significantly. An example of requirements is shown below in Table 2 for intra-frequency CRS-based measurements. The measurement time may be defined as ([N]+M)*TDMTC_periodicity. N is the required amount of DRS occasions. M is the number of configured discovery signal occasions which are not available during Tₘₑₐₛᵤᵣₑ_{_}ᵢₙₜᵣₐ_{_}_{FS3}_{_}_{CRS} for the measurements at the UE due to the absence of the necessary radio signals from the cell (for example due to LBT failure).

TABLE 2
Intra-frequency measurement requirements under operation with frame
structure 3

| | CRS measurement | | |
|---|---|---|---|
| .SCH Ês/Iot | bandwidth [RB]^{Note2} | CRS Ês/Iot | Tₘₑₐₛᵤᵣₑ_{_{—}}ᵢₙₜᵣₐ_{_{—}}_{FS3}_{_{—}}_{CRS} [ms] |
| [0] ≤ SCH Ês/Iot | <25 | [−6] ≤ CRS Ês/Iot | ([5] + M) * T_{DMTC}_{_{—}}_{periodicity} |
| [−6] ≤ SCH Ês/Iot < [0] | <25 | | ([20] + M) * T_{DMTC}_{_{—}}_{periodicity} |
| [0] ≤ SCH Ês/Iot | ≥25 | [0] ≤ CRS Ês/Iot | ([1] + M) * T_{DMTC}_{_{—}}_{periodicity} |
| [−6] ≤ SCH Ês/Iot < [0] | ≥25 | | ([4] + M) * T_{DMTC}_{_{—}}_{periodicity} |

NOTE1: Discovery signal occasion duration (ds-OccasionDuration) is 1 ms.
^{Note2}The requirements for measurement bandwidth ≥ 25 RB are optional.

An eNodeB may not know what kind of SCH Ės/Iot or CRS Ės/Iot level the UE is experiencing and/or what measurement bandwidth the UE is supporting. Hence, the eNodeB does not know which measurement requirement (i.e., N) the UE is following.

Additionally, total measurement time does not only depend on SINR level and measurement bandwidth, but also on LBT. The measurement time is increased with one DMTC period each time the channel is occupied during a whole DMTC period and DRS cannot be transmitted (M in table 2). An eNodeB knows the result of LBT, so the eNB is aware that UE cannot be performing measurements if DRS wasn't transmitted.

It may be desirable to prevent too long or even infinite measurement times. The infinite measurement time discussion in RAN4 aims at defining a way to restrict measurement time in a channel, where eNodeB LBT frequently blocks DRS transmission. Two options have been discussed for restricting measurement and cell identification requirements:

Option 1: If the interval between two available measurement occasions is larger than a certain number (to be determined) of seconds or DMTC periods, the cell is considered by a UE to be undetectable.

Option 2: A maximum measurement time is defined. Requirements apply if DRS is present in more than a certain percentage (to be determined) of all DMTC occasions within a defined cell identification or measurement time (i.e. M does not exceed a certain percentage of all configured discovery signal occasions within cell identification or measurement time). That is, measurement is valid only if the required DRS occasions occur within a defined maximum time (e.g. within a defined maximum amount of DMTC occasions).

Applying either of these options may provide the eNodeB with an indication of the maximum measurement time to expect from the UE. However, restarting the measurement may cause further delays. If option 1 is chosen, the measurement may be restarted if, after a DRS that is available at the UE, there is no DRS available within time X. With option 2 the measurement may be restarted, depending on the UE implementation, either when the maximum measurement time is exceeded and there have not been enough DRS occasions available or the maximum value for M is exceeded, in which case the measurement may be restarted before the maximum total time is exceeded. These options may make the measurement time more variable, and thus make it harder for an eNodeB to keep track of when a measurement report may be available at the UE.

If the UE almost completes the measurement, for example is able to perform measurements over four out of five DRS, but the maximum time is exceeded, the eNodeB may never know the result of measurement during the time the channel was not occupied. LBT blocking may come in bursts, and it is possible that the channel may be heavily occupied only temporarily. In this situation, it may be useful for the eNodeB to know the channel conditions, even though the channel is occupied most of the time during that particular measurement.

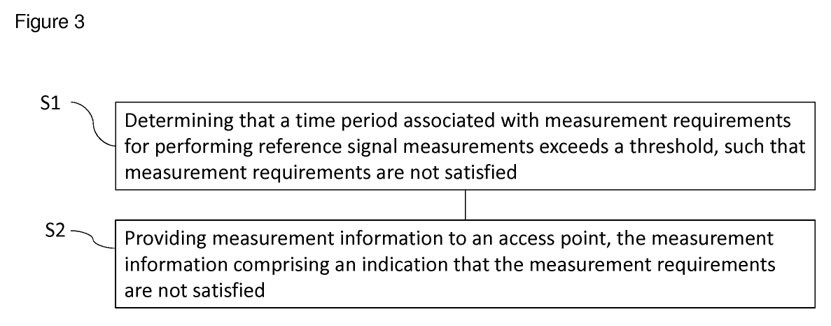

FIG. 3 shows a flowchart of an example method according to some embodiments. The method comprises, in a first step S1, determining that a time period associated with measurement requirements for performing reference signal measurements exceeds a threshold, such that the measurement requirements are not satisfied.

In a second step S2, the method comprises providing measurement information to an access point, the measurement information comprising an indication that the measurement requirements are not satisfied.

The time period may comprise at least one of a time period between receiving a first reference signal and a second reference signal and a maximum time period for performing reference signal measurements. Where the time period is a maximum time period for performing reference signal measurements, the threshold may be defined as a number of DRS occasions which were missing during that time period.

The method provides steps such that if the maximum total measurement time (and/or number of missed DRS occasions within a maximum total measurement time) (option 2), the maximum period between two consecutive DRS (option 1), a specified time with no DRS transmission or any other specified timer or threshold is exceeded and the measurement fails (and is restarted), the UE indicates this to the eNodeB. This gives the eNodeB information that the UE is measuring, but in current conditions the measurement was not successful.

The measurement requirements may comprise performing a plurality of reference signal measurements. The method may comprise performing at least one reference signal measurement of the plurality of reference signals.

In one embodiment, partial measurement reporting may be provided in LAA. The information may include the results of the reference signal measurements that have been performed, e.g., a partial measurement report. A partial measurement report, or any other report, would be based on the DRS that were averaged during the measurement before the measurement failed (and was restarted). The report may also include an indication that the measurement was incomplete.

A partial measurement report may be similar to an LTE measurement report, any other suitable report type or style might be used. The partial measurement report may include the following additional indicators: an indication that the measurement was incomplete and/or the completion level of the measurement. In an embodiment, the measurement information may comprise an indication of the number of performed reference signal measurements. The indication may be provided as a percentage (e.g. 4/5 DRS used: 80% completion level) and/or the amount of DRS (e.g. 4 DRS used). The report may also include an indication of which subframe the measurement failed due to exceeded measurement time or any other specified condition.

The measurement information may comprise the results of the reference signal measurements that have been performed if a defined number of measurements has been reached. In an embodiment, the partial measurement report may be provided only when a high enough completion level is reached. For example, measurements based on higher than 50% of the desired amount of DRS may be reported. The desired minimum completion level may be configured by the eNodeB.

The report could be sent in the case where, based on the incomplete measurement, a measurement event would be triggered. That is, after triggering of a measurement event, based on the performed reference signal measurements, the measurement information may be provided. This report, i.e. the indication of the at least one reference signal measurement, may be used by the eNodeB as a reference.

In one embodiment, the report may be defined such that the UE sends measurement information after a given time period, i.e. after expiry of a timer. This may enable periodic measurement reports from the UE with the measurement report being triggered by expiry of a timer, rather than a measurement condition. This may be configured in addition or as an alternative to other event triggered report conditions. UE would sent a partial report when the timer expires.

The measurement information The UE normally reports the unlicensed LAA secondary cell measurements on the primary licensed cell, since before Rel-14 eLAA there is no uplink on the unlicensed bands. From Rel-14 onwards (and in MulteFire) the measurement reports may be sent on the unlicensed band.

If the UE indicates to the eNodeB only that measurement was restarted, this may be done by utilizing the LTE measurement report, although any other suitable report types may be used. The UE may send an empty measurement report, which could indicate that measurement was failed (and restarted) and additionally, in which subframe this happened.

Measurement information, such as a partial measurement report may be sent by the UE in a periodic (or non-periodic) manner e.g. depending on whether other reports are sent by the UE (including LAA cells), a given time has passed since last (partial) report has been sent and/or there is a continuous failing to detect cells. UE could also send reports based on other conditions such as being configured with LAA cell (or MulteFire), inter-frequency measurement including carriers with LAA and/or MulteFire type of cell (applying LBT) and/or when having active data transmissions.

The advantage of partial measurement reporting would be that measurements may still be utilized in the case they were not completed and/or close to completion. With partial reporting eNodeB may get at least some channel or carrier information. The eNB may use the partial report as a reference of the channel conditions between the occupied periods. Partial measurement reporting may also give the eNodeB an indication that the UE is measuring, but currently the conditions are not good enough for completing the measurement.

In the above examples, an eNB has been used as an example of a base station. However, similar principles may be applied to any suitable base station,

Although reference signal measurements have been referred to above, any suitable channel measurements may be used.

It should be noted that partial measurement reporting can be utilized also in MulteFire or other systems utilizing unlicensed spectrum.

It should be understood that each block of the flowchart of the Figures and any combination thereof may be implemented by various means or their combinations, such as hardware, software, firmware, one or more processors and/or circuitry.

It is noted that whilst embodiments have been described in relation to one example of a LTE network, similar principles may be applied in relation to other examples of 3G, LTE or 5G networks. It should be noted that other embodiments may be based on other cellular technology other than LTE or on variants of LTE. Some embodiments may support regular LTE by extending LTE service into unlicensed radio band or shared spectrum using, for example, a so-called MuLTEfire radio. However it should be appreciated that embodiments are not limited to a MuLTEfire radio, or a LTE type of cellular service, and could support e.g., a 3G radio service or a 5G radio service. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

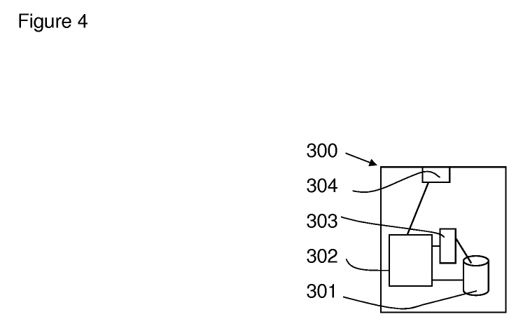

The method may be implemented in such as a control apparatus as shown in FIG. 4. The method may be implanted in a single processor 201 or control apparatus or across more than one processor or control apparatus. FIG. 4 shows an example of a control apparatus for a communication system, for example to be coupled to and/or for controlling a station of an access system, such as a RAN node, e.g. a base station, (e) node B, a central unit of a cloud architecture or a node of a core network such as an MME or S-GW, a scheduling entity such as a spectrum management entity, or a server or host. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 or processor 201 can be configured to execute an appropriate software code to provide the control functions. Control functions may comprise determining that a time period associated with measurement requirements for performing reference signal measurements exceeds a threshold, such that the measurement requirements are not satisfied and providing measurement information to an access point, the measurement information comprising an indication that the measurement requirements are not satisfied.

Alternatively, or in addition, control functions may comprise receiving measurement information from a user device, the measurement information comprising an indication that measurement requirements for performing reference signal measurements are not satisfied, wherein the user device has determined that a time period associated with the measurement requirements exceeds a threshold, such that the measurement requirements are not satisfied.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

Indeed there is a further embodiment comprising a combination of one or more embodiments with any of the other embodiments previously discussed.

1.-18. (canceled)

19. A method, comprising:
Determining, at a user device, that measurement requirements are not satisfied; and
providing measurement information, to an access point, indicating that the measurement requirements are not satisfied.

20. The method according to claim 19, wherein the determining comprises determining that a time period associated with the measurement requirements exceeds a threshold.

21. The method according to claim 20, wherein the time period comprises at least one of a time period between receiving a first reference signal and a second reference signal, and a maximum time period for performing reference signal measurements.

22. The method according to claim 19, comprising performing at least one reference signal measurement of a plurality of reference signal measurements.

23. The method according to claim 22, wherein the measurement information comprises an indication of the at least one reference signal measurement.

24. The method according to claim 19, wherein providing the measurement information comprises performing a plurality of reference signal measurements.

25. The method according to claim 24, wherein providing the measurement information comprises providing an indication of the number of the performed reference signal measurements.

26. The method according to claim 19, wherein the providing comprises providing the measurement information on expiry of a timer.

27. The method according to claim 19, wherein the providing comprises providing the measurement information after triggering of a measurement event.

28. The method according to claim 19, wherein the providing comprises providing the measurement information using unlicensed spectrum.

29. A method comprising:
Receiving, at a network element, measurement information from a user device, the measurement information comprising an indication that measurement requirements are not satisfied.

30. The method according to claim 29, wherein the measurement information comprises an indication that a time period associated with the measurement requirements exceeds a threshold.

31. The method according to claim 30, wherein the time period comprises at least one of a time period between receiving, at the user device, a first reference signal and a second reference signal and a maximum time period for performing, at the user device, reference signal measurements.

32. The method according to claim 31, wherein the measurement information comprises an indication of the number of performed reference signal measurements at the user device.

33. The method according to claim 29, wherein the receiving comprises receiving the measurement information on expiry of a timer.

34. The method according to claim 29, wherein the receiving comprises receiving the measurement information after triggering of a measurement event at the user device.

35. The method according to claim 29, wherein the receiving comprises receiving the measurement information using unlicensed spectrum.

36. An apparatus, comprising:
at least one processor; and
at least one memory including a computer program code, the at least one memory and the computer program code configured to, with the at least one processor, cause the apparatus at least to:
determine that measurement requirements are not satisfied; and
provide measurement information, to an access point, indicating that the measurement requirements are not satisfied.

37. The apparatus according to claim 36, wherein the at least one memory and the computer program code are configured, with the at least one processor, to cause the apparatus to:
determine that a time period associated with the measurement requirements exceeds a threshold.

38. An apparatus comprising:
at least one processor; and
at least one memory including a computer program code, the at least one memory and the computer program code configured to, with the at least one processor, cause the apparatus at least to:
receive measurement information from a user device, the measurement information comprising an indication that measurement requirements are not satisfied.
